(19) United States
(12) Patent Application Publication
(10) Pub. No.: US 2019/0036355 A1
(43) Pub. Date: Jan. 31, 2019

(54) Method and Device for Equalizing Storage Battery for Photovoltaic Energy Storage System and Photovoltaic Energy Storage System

(71) Applicant: Beijing Chuangyu Technology Co., Ltd, Beijing (CN)

(72) Inventors: Haixia SU, Beijing (CN); Ying ZHANG, Beijing (CN); Xiang TONG, Beijing (CN)

(21) Appl. No.: 16/022,739

(22) Filed: Jun. 29, 2018

(30) Foreign Application Priority Data
Jul. 26, 2017 (CN) 201710616073.7

(51) Int. Cl. H02J 7/00; H02J 3/38; H02J 7/35; H02J 3/32

(52) U.S. Cl. CPC H02J 7/0019; H02J 3/383; H02J 3/32; H02J 7/0021; H02J 7/35

(57) ABSTRACT

Disclosed are a method and device for equalizing storage battery for a photovoltaic energy storage system and the photovoltaic energy storage system. The method for equalizing storage battery includes: step 1, it is judged whether a photovoltaic energy storage system is in an energy storage state, if yes, entering step 2, and in a case that the photovoltaic energy storage system is not in the energy storage state, continuing to execute step 1; step 2, it is judged whether a storage battery pack needs to be equalized, if yes, entering step 3, and otherwise, returning to step 1; and step 3, the storage battery pack is equalized, and the storage battery pack is continued to be charged after equalization is completed.

The present application claims benefit of China Patent Application No. 201710616073.7. filed on Jul. 26, 2017 and entitled “Method and Device for Equalizing Storage Battery for Photovoltaic Energy Storage System and Photovoltaic Energy Storage System”, the contents of which are hereby incorporated by reference in its entirety.

### TECHNICAL FIELD

The embodiments of the disclosure relate to the technical field of photovoltaic energy storage, and more particularly to a method and device for equalizing storage battery for a photovoltaic energy storage system, and the photovoltaic energy storage system.

### BACKGROUND

A photovoltaic energy storage system uses a photovoltaic cell to generate power, the generated power may be directly supplied to a load, and excess energy may also be stored in a storage battery. In a case that the weather condition is not suitable for the power generation of the photovoltaic cell or the generated power cannot meet the load demand, the storage battery may supply electric energy to the load.

Common photovoltaic energy storage systems include solar street lamps, home photovoltaic systems, etc. In the two common photovoltaic energy storage systems, the load demand does not always exist. For example, solar street lamps do not need to be turned on during the day, and power generated by the photovoltaic cell is stored in a storage battery. In a case that the night comes, the power of the storage battery is provided for the street lamps. Inconsistency in capacity and internal resistance of will be caused during the production process and during use of the storage battery in the photovoltaic energy storage system, and as the use time is prolonged, the difference between single batteries will become larger and larger, resulting in shortening of the service life of the battery.

For the inconsistency in capacity and internal resistance of the storage battery, the current solution is mainly to use a Battery Management System (BMS) of the storage battery to equalize the battery. There are two main equalization technologies. One technology is passive equalization, wherein single batteries are connected with resistors in parallel to consume electric energy, the passive equalization is inefficient and wastes electric energy. The other technology is active equalization, which involves energy transfer between single batteries, so it is efficient but costly.

The current storage battery equalization technology is mainly designed solely for the storage battery. The commonly adopted method is to equalize the battery in the BMS, the structural characteristics of the photovoltaic energy storage system are not taken into consideration, and special equalization hardware needs to be added. The passive equalization requires the addition of parallel resistors. The active equalization requires the addition of a power transfer component such as a capacitor or a Direct Current-Direct Current converter (DC-DC).

### SUMMARY

In order to solve the above technical problem, the embodiments of the disclosure provide a method for equalizing storage battery for a photovoltaic energy storage system. The method includes:

step 1, it is judged whether a photovoltaic energy storage system is in an energy storage state, in a case that the photovoltaic energy storage system is in the energy storage state, entering step 2, and in a case that the photovoltaic energy storage system is not in the energy storage state, continuing to execute step 1;

step 2, it is judged whether a storage battery pack needs to be equalized, in a case that the storage battery pack needs to be equalized, entering step 3, and in a case that the storage battery pack need not to be equalized, returning to step 1; and

step 3, the storage battery pack is equalized, and the storage battery pack is continued to be charged after equalization is completed.

In at least one alternative embodiment, a working state of the photovoltaic energy storage system is determined according to the power generation amount of at least one photovoltaic cell, the SOC of a storage battery, and the connection condition of at least one load.

The energy storage state refers to that there is no load connected to a DC-DC of the photovoltaic energy storage system, the at least one photovoltaic cell is in a power generation state and the power generation amount meets the charge requirements of the storage battery, and the at least one photovoltaic cell charges the storage battery through the DC-DC.

A photovoltaic power supply state refers to that the at least one load is connected to the DC-DC, the at least one photovoltaic cell is in a power generation state and the power generation amount can meet the power supply requirements of the at least one load, and the photovoltaic cell directly supplies power to the load through the DC-DC.

A storage battery power supply state refers to that the at least one load is connected to the DC-DC, the at least one photovoltaic cell cannot generate power or is in a power generation state but the power generation amount cannot meet the power supply requirements of the at least one load, and the storage battery pack supplies power to the at least one load.

In at least one alternative embodiment, it is judged whether a storage battery pack needs to be equalized in the following manner:

In a case that the State of Charge (SOC) of the storage battery pack reaches a predetermined threshold and the voltage of a single battery in the storage battery pack meets a predetermined equalization condition, determining that the storage battery needs to be equalized, and in a case that the SOC of the storage battery pack does not reach the predetermined threshold and/or the voltage of a single battery in the storage battery pack does not meet the predetermined equalization condition, determining that the storage battery pack does not need to be equalized.

In at least one alternative embodiment, the situation that the voltage of a single battery in the storage battery pack meets a predetermined equalization condition refers to that the difference between a maximum voltage of the single battery in the storage battery pack and a average voltage of the storage battery pack is greater than 5% of the average voltage of the storage battery pack; or, the difference between a maximum voltage and a minimum voltage of the single battery in the storage battery pack is greater than 10% of the average voltage of the storage battery pack.

Herein, the average voltage of the storage battery pack is an average voltage value of all single batteries in the storage battery pack.

In at least one alternative embodiment, the storage battery pack is equalized in the following manners:

all single batteries in the storage battery pack are sorted according to a voltage level of the single batteries: and

the single batteries except for the single battery having the highest voltage in the storage battery pack are sequentially charged and equalized in an ascending order of the voltage value, wherein in a case that each single battery is charged and equalized, only the single battery is connected to the DC-DC, the other single batteries are disconnected from the DC-DC. in a case that the absolute value of the difference between the voltage of the single battery and the maximum voltage of the single batteries is less than 2% of the maximum voltage of the single batteries, the single battery stops being charged and equalized, and a subsequent single battery continues to be charged and equalized, and in a case that all the single batteries except for the single battery having the largest voltage in the storage battery pack have been completely charged and equalized, equalization for the storage battery pack is completed.

In at least one alternative embodiment, the method further includes: secondarily equalizing, after continuing to charge the storage battery pack, the storage battery pack in the following manners:

in a case that continuing to charge the storage battery pack, when a SOC of the storage battery pack is less than 90%, charging the entire storage battery pack, and in a case that the SOC of the storage battery pack reaches 90%, stopping charging, and returning to step 2; and

in a case that continuing to charge the storage battery pack, when the SOC of the storage battery pack is greater than 90%, charging the entire storage battery pack, and in a case that the maximum voltage of a single battery in the storage battery pack reaches a rated voltage, stopping charging, and returning to step 2.

In at least one alternative embodiment, the method also includes:

directly returning to step 1 in a case that it is detected that at least one load is connected to the DC-DC of the photovoltaic energy storage system during step 2, step 3 and step 4.

In addition, the embodiments of the disclosure also provide a device for equalizing storage battery for a photovoltaic energy storage system. The device is applied to a photovoltaic controller of a photovoltaic energy storage system. The device includes:

a state detection component, configured to judge whether the photovoltaic energy storage system is in an energy storage state, and notify, in a case that the photovoltaic energy storage system is in the energy storage state, an equalization control component;

the equalization control component, configured to judge whether a storage battery pack needs to be equalized, equalize, in a case that the storage battery pack needs to be equalized, various single batteries in the storage battery pack, and after equalization is completed, notify a charging control component; and

the charging control component, configured to charge the entire storage battery pack.

In at least one alternative embodiment, the state detection component determines a working state of the photovoltaic energy storage system according to the power generation amount of at least one photovoltaic cell, a State of Charge (SOC) of a storage battery, and a connection condition of at least one load.

The energy storage state refers to that there is no load connected to a DC-DC of the photovoltaic energy storage system, the at least one photovoltaic cell is in a power generation state and the power generation amount meets the charge requirements of the storage battery, and the at least one photovoltaic cell charges the storage battery through the DC-DC.

A photovoltaic power supply state refers to that the at least one load is connected to the DC-DC, the at least one photovoltaic cell is in a power generation state and the power generation amount can meet the power supply requirements of the at least one load, and the photovoltaic cell directly supplies power to the load through the DC-DC.

A storage battery power supply state refers to that the at least one load is connected to the DC-DC, the at least one photovoltaic cell cannot generate power or is in a power generation state but the power generation amount cannot meet the power supply requirements of the at least one load, and the storage battery pack supplies power to the at least one load through the DC-DC.

In at least one alternative embodiment, the equalization control component judges whether a storage battery pack needs to be equalized in the following manner:

in a case that the SOC of the storage battery pack reaches a predetermined threshold and the voltage of a single battery in the storage battery pack meets a predetermined equalization condition, determining that the storage battery needs to be equalized, and in a case that the SOC of the storage battery pack does not reach a predetermined threshold and/or the voltage of a single battery in the storage battery pack does not meet a predetermined equalization condition, determining that the storage battery pack does not need to be equalized.

In at least one alternative embodiment, the situation that the voltage of a single battery in the storage battery pack meets a predetermined equalization condition refers to that the difference between a maximum voltage of the single battery in the storage battery pack and a average voltage of the storage battery pack is greater than 5% of the average voltage of the storage battery pack; or, the difference between a maximum voltage and a minimum voltage of the single battery in the storage battery pack is greater than 10% of the average voltage of the storage battery pack; and the average voltage of the storage battery pack is an average voltage value of all single batteries in the storage battery pack.

In at least one alternative embodiment, the equalization control component equalizes the storage battery pack in the following manners:

all single batteries in the storage battery pack are sorted according to a voltage level of the single batteries: and

the single batteries except for the single battery having the highest voltage in the storage battery pack are sequentially charged and equalized in an ascending order of the voltage value,

wherein in a case that each single battery is charged and equalized, only the single battery is connected to the DC-DC, the other single batteries are disconnected from the DC-DC, in a case that the absolute value of the difference between the voltage of the single battery and the maximum voltage of the single batteries is less than 2% of the maximum voltage of the single batteries, the single battery stops being charged and equalized, and a subsequent single battery continues to be charged and equalized, and in a case that all the single batteries except for the single battery having the largest voltage in the storage battery pack have been completely charged and equalized, equalization for the storage battery pack is completed.

In at least one alternative embodiment, the charging control component is also configured to secondarily equalize, after continuing to charge the storage battery pack, the storage battery pack in the following manners:

in a case that the storage battery pack is continued to be charged, when a SOC of the storage battery pack is less than 90%, the entire storage battery pack is charged, and in a case that the SOC of the storage battery pack reaches 90%, stopping charging, and notifying the equalization control component to secondarily equalize the storage battery pack; and when the SOC of the storage battery pack is greater than 90%, charging the entire storage battery pack, and in a case that the maximum voltage of a single battery in the storage battery pack reaches a rated voltage, stopping charging, and notifying the equalization control component to secondarily equalize the storage battery pack.

In at least one alternative embodiment, the state detection component is also configured to notify, in a case that it is detected that at least one load being connected to the DC-DC of the photovoltaic energy storage system, the equalization control component and the charging control component, and in a case that the equalization control component and the charging control component receive a load connection notification of the state detection component, stop equalizing or charging the storage battery pack. In addition, the embodiments of the disclosure also provide a photovoltaic energy storage system. The photovoltaic energy storage system includes a photovoltaic cell, a photovoltaic controller, a DC-DC, and a storage battery pack, wherein the photovoltaic controller includes any one device for equalizing storage battery in the embodiments of the disclosure.

### BRIEF DESCRIPTION OF THE DRAWINGS

FIG. 1 is a schematic topological diagram of a photovoltaic energy storage system;

FIG. 2 is a schematic diagram of a connection structure of a DC-DC and a storage battery in a photovoltaic energy storage system;

FIG. 3 is a schematic diagram of main steps of a method for equalizing storage battery for a photovoltaic energy storage system according to Embodiment 1 of the disclosure;

FIG. 4 is a schematic diagram of main steps of a method for equalizing storage battery for a photovoltaic energy storage system according to Embodiment 2 of the disclosure; and

FIG. 5 is a schematic composition diagram of a device for equalizing storage battery for a photovoltaic energy storage system according to Embodiment 3 of the disclosure.

### DETAILED DESCRIPTION OF THE EMBODIMENTS

To make the objectives, technical solutions and advantages of the disclosure clearer, the implementation manners of the disclosure will be further described in detail below with reference to the accompanying drawings.

### Embodiment 1

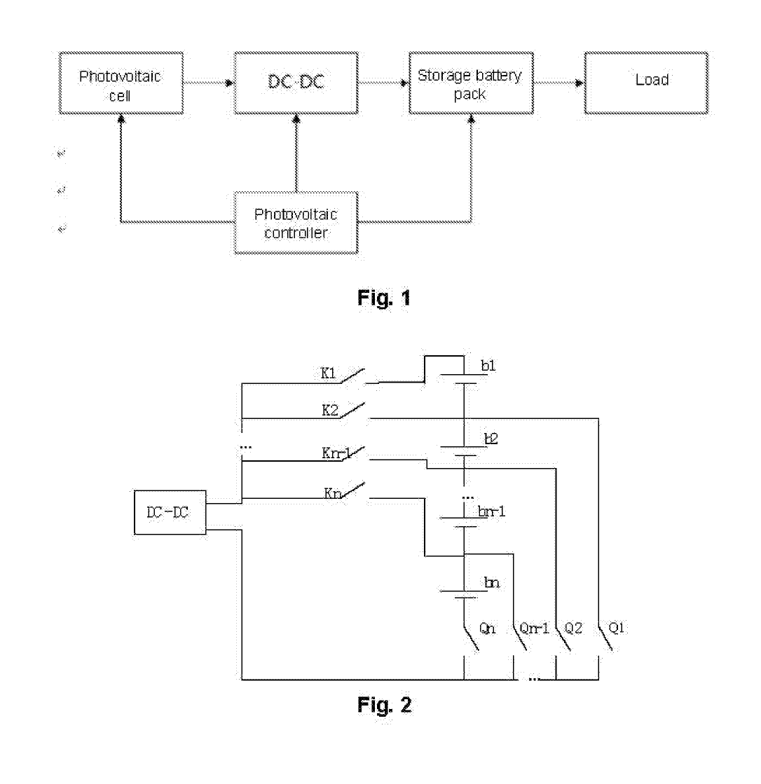

FIG. 1 shows a topological structure of a common photovoltaic energy storage system. The topological structure of the photovoltaic energy storage system mainly includes a photovoltaic cell, a DC-DC. a photovoltaic controller, a storage battery pack, and a load, wherein the DC-DC is used for converting a voltage to a voltage suitable for charging a storage battery.

The manner of connecting the DC-DC and the storage battery in the photovoltaic energy storage system is as shown in FIG. 2 n storage batteries in a storage battery pack are connected in series, denoted by b1, b2, . . . , bn-1, and bn, respectively. Switches are denoted by K1, K2, . . . , Kn-1, Kn, Q1, Q2, . . . , Qn-1, and Qn. One of single batteries in the storage battery pack may be selected to be connected to the DC-DC by turning on or off the switches. An MOS tube is selected as a switch to increase the turn on-off speed of the switch and reduce the power loss. The turn on-off of the MOS tube is driven by the photovoltaic controller. For example, when the single battery bm (m=1, 2 , . . . , n) is connected to the DC-DC. the photovoltaic controller drives the switches Km (m=1, 2, n) and Qm (m=1, 2, . . . , n) to be turned on while the other switches are turned off.

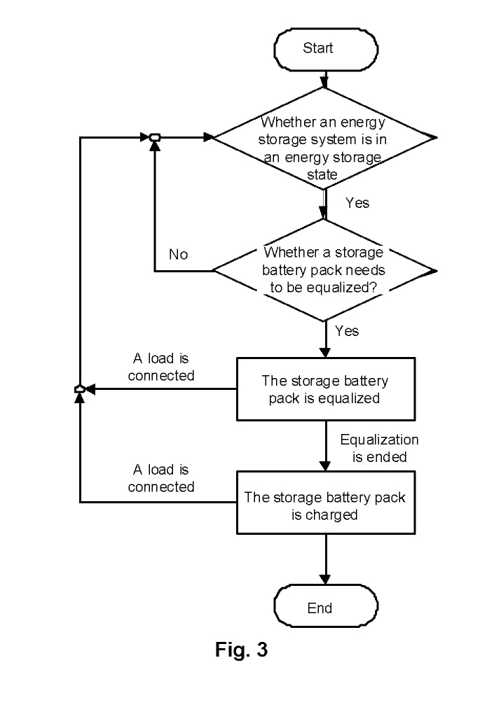

A method for equalizing storage battery for a photovoltaic energy storage system of the present embodiment is as shown in FIG. 3. The method mainly includes the steps as follows.

In step 1, it is judged whether a photovoltaic energy storage system is in an energy storage state, in a case that the photovoltaic energy storage system is in an energy storage state, step 2 is entered, and in a case that the photovoltaic energy storage system is not in an energy storage state, judgment is continued.

In some embodiments of the disclosure, the working state of the photovoltaic energy storage system is divided into three working states. The first one is the energy storage state, where the load is not connected to a DC-DC, that is, the load is not required for power supply, the light conditions meet the power generation requirements of a photovoltaic cell, and the photovoltaic cell converts solar energy to electric energy, and then charges a storage battery through the DC-DC. The second one is a photovoltaic cell power supply state, where the at least one load is connected to the DC-DC, the at least one photovoltaic cell is in a power generation state and the power generation amount can meet the power supply requirements of the at least one load, and the photovoltaic cell generates power and directly supplies power to the load through the DC-DC. The third one is a storage battery power supply state, where the at least one load is connected to the DC-DC, but the at least one photovoltaic cell cannot generate power at this time or is in a power generation state but the power generation amount cannot meet the power supply requirements of the at least one load, and the storage battery pack supplies power to the at least one load through the DC-DC.

During the working period, the photovoltaic energy storage system will be converted among the three working states. The photovoltaic controller may control the conversion of the working states according to the power generation amount of the photovoltaic cell, the power supply requirements of the load, and the SOC of the storage battery. The photovoltaic controller may judge whether there is a load connected to the DC-DC by monitoring the voltage or current across both ends of the switch between the DC-DC and the load. When the photovoltaic controller determines that the energy storage system is in the energy storage state at this time, step 2 is entered, and otherwise, judgment is continued.

In step 2, it is judged whether a storage battery pack needs to be equalized, in a case that the storage battery pack needs to be equalized, step 3 is entered, and in a case that the storage battery pack does not need to be equalized, step 1 is re-executed.

The photovoltaic controller can monitor the voltage of the entire storage battery pack and calculate the SOC, and also monitor the voltage of each single battery in the storage battery pack.

In some embodiments of the disclosure, when the storage battery pack meets the following two conditions simultaneously, it is indicated that the storage battery pack needs to be equalized and step 3 is entered, and in a case that the storage battery pack does not meet the following two conditions simultaneously, equalization is not needed

The first condition is that the SOC of the storage battery pack is equal to or greater than a predetermined threshold, for example, it is satisfied that SOC≥80%.

The purpose of the storage battery pack in the energy storage state is to charge the storage battery so as to supply power to the load in a case that the load is connected and the photovoltaic cell generates insufficient power. Therefore, in the disclosure, it is firstly ensured that the storage battery has stored a certain amount of power, and the amount of power may basically meet the power supply requirements of the at least one load. On this basis, the storage battery pack is equalized

The second condition that the voltage of a single battery in the storage battery pack meets a predetermined equalization condition, and meets, for example, the following formula:

$$\frac{U max - U ave}{U ave} * 100 \% > 5 \%$$

wherein the photovoltaic controller monitors the voltage of each single battery, the voltage of n single batteries in the storage battery pack is denoted as U1, U2, . . . , Un-1, and Un, the average voltage value of all single batteries is denoted as Uave. the maximum voltage of the single battery is denoted as Umax, and the minimum voltage of the single battery is denoted as Umin.

That is, the equalization condition is that the difference between the maximum voltage of the single battery and the average voltage of the storage battery pack is greater than 5% of the average voltage.

In addition, the equalization condition may alternatively be the following formula:

$$\frac{U max - U min}{U ave} * 100 \% > 10 \%$$

That is, the equalization condition may also be that the difference between the maximum voltage of the single battery and the minimum voltage is greater than 10% of the average voltage.

In some embodiments of the disclosure, as long as one of the above two formulae is satisfied, it is indicated that the storage battery pack needs to be equalized.

In step 3, each single battery in the storage battery pack is equalized, and step 4 is entered after equalization is completed.

Specifically, in a case that the batteries in the storage battery pack are equalized, all single batteries in the storage battery pack are sorted in an ascending order of voltage, denoted as b_L1, b_L2, b_Ln-1, and b_Ln, serving as an equalization sequence of single batteries.

First, the single battery b_L1 having the lowest voltage is charged, and the photovoltaic controller controls the turn on-off of a switch corresponding to the single battery b_L1 to select the single battery, such that the single battery is connected to the DC-DC while the other single batteries are disconnected from the DC-DC.

Then, the photovoltaic controller adjusts the output voltage of the DC-DC to charge the single battery. That is, when the current output voltage of the photovoltaic cell is smaller than that of the single battery, it is necessary to increase the output voltage of the DC-DC by utilizing the boost function of the DC-DC to charge the single battery. In a case that the voltage of the single battery meets the following formula, the single battery stops being charged:

$$\vert \frac{U - U max}{U max} \vert * 100 \% < 2 \%$$

wherein U is the voltage of the single battery b_L1 that is currently equalized. That is, in a case that the absolute value of the difference between the voltage of the single battery and the maximum voltage of the single batteries is less than 2% of the maximum voltage of the single batteries, the single battery stops being charged and equalized.

After the single battery b_L1 is completely equalized, the single battery b_L2 starts to be equalized, and in a case that an equalization ending condition is satisfied, the single battery stops being equalized. The single batteries are sequentially equalized according to an ascending order of voltage, wherein the single battery having the maximum voltage does not need to be equalized. That is, n−1 single batteries except for the single battery having the maximum voltage need to be charged and equalized.

If the load is connected and needs to be powered by the photovoltaic cell or the storage battery in the process of equalizing the single batteries in the storage battery pack, the single batteries stop being equalized, and step 1 is re-executed, when the n−1 single batteries are completely equalized, step 4 is entered.

In step 4, the storage battery pack continues to be charged.

In some embodiments of the disclosure, after the storage battery pack is completely equalized, the storage battery pack continues to be charged. After charging is completed, the flow is ended, and the next equalization process is waited; or, step 1 is re-executed directly.

In addition, when the load is connected to the DC-DC in the charging process, charging is stopped, and step 1 is re-executed.

According to the method and device for equalizing storage battery for a photovoltaic energy storage system provided above in the embodiments of the disclosure, a photovoltaic cell and a photovoltaic controller contained in the photovoltaic energy storage system are used to equalize a storage battery, so the consistency in single batteries in a storage battery pack during use is improved, thereby prolonging the service life of the storage battery. Compared with a photovoltaic energy storage system for equalization employing a BMS in the related art, the photovoltaic energy storage system provided in the embodiments of the disclosure equalizes the storage battery by directly using the photovoltaic cell and the photovoltaic controller without addition of another equalization hardware, thereby not only reducing the hardware cost of a BMS equalization portion, but also fully utilizing the power generation amount of the photovoltaic cell, improving the use efficiency of the photovoltaic cell, and prolonging the life of the storage battery.

Compared with the related art, the above technical solution of the embodiments of the disclosure has at least one of the following advantages:

1. prolonging of the life of a storage battery: by equalizing the storage battery, the embodiments of the disclosure improves the consistency in single batteries in a storage battery pack during use, thereby prolonging the service life of the storage battery;

2. cost reduction: the embodiments of the disclosure is applied to a photovoltaic energy storage system, and fully utilizes a photovoltaic cell and a photovoltaic controller contained in the energy storage system to equalize a battery, wherein a DC-DC is contained in the energy storage system, and compared with equalization employing a BMS in the energy storage system, the embodiments of the disclosure reduce the cost; and

3. improvement of the use efficiency of photovoltaic cells: the embodiments of the disclosure are performed in a case that the energy storage system is in an energy storage state, and the SOC of the storage battery is greater than 80%, thereby not only meeting the energy storage requirement of the storage battery, but also equalizing the storage battery; compared with disconnecting the photovoltaic cell after the storage battery is fully charged, the embodiments of the disclosure utilize the power generation amount of the photovoltaic cells to equalize the storage battery pack, and improves the use efficiency of the photovoltaic cells.

### Embodiment 2

The main difference between the method for equalizing storage battery for a photovoltaic energy storage system of the present embodiment and Embodiment 1 is that in Embodiment 1, only when it is determined that the SOC of the storage battery is greater than a predetermined threshold (for example. 80%, but not limited to 80%) and a predetermined equalization condition is satisfied, each single battery in the storage battery pack is charged and equalized; and In some embodiments of the disclosure, after various single batteries in the storage battery pack are completely charged and equalized and the storage battery pack continues to be charged, the storage battery pack is secondarily equalized.

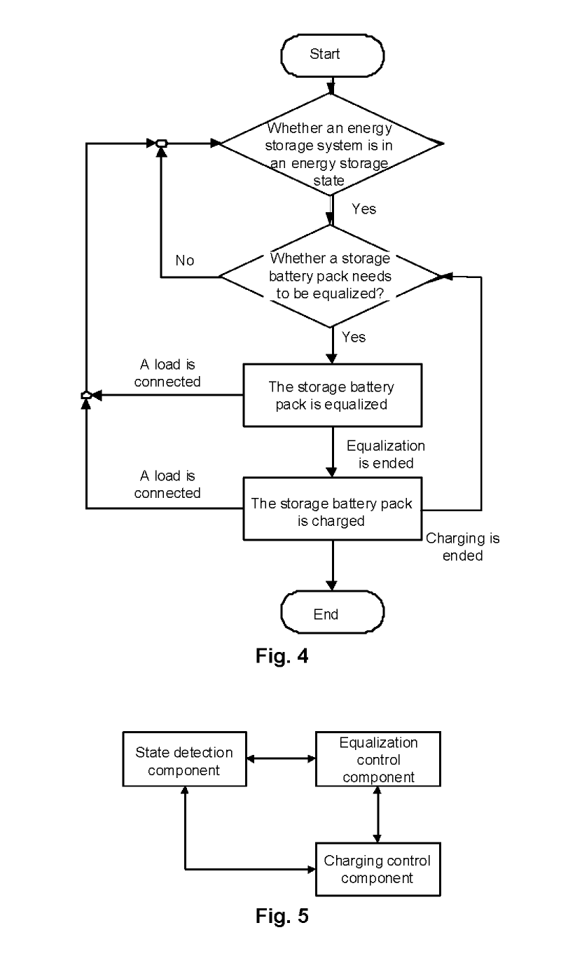

As shown in FIG. 4, the method for equalizing storage battery for a photovoltaic energy storage system of the present embodiment mainly includes the steps as follows.

In step 1, it is judged whether a photovoltaic energy storage system is in an energy storage state, in a case that the photovoltaic energy storage system is in the energy storage state, step 2 is entered, and in a case that the photovoltaic energy storage system is not in the energy storage state, judgment is continued

In step 2, it is judged whether a storage battery pack needs to be equalized, in a case that the storage battery pack needs to be equalized, step 3 is entered, and in a case that the storage battery pack don't needs to be equalized, step 1 is re-executed.

In step 3, each single battery in the storage battery pack is equalized, and step 4 is entered after equalization is completed.

The single batteries are sequentially equalized according to an ascending order of voltage, wherein the single battery having the maximum voltage does not need to be equalized. That is, n−1 single batteries except for the single battery having the maximum voltage need to be charged and equalized.

If the load is connected and needs to be powered by the photovoltaic cell or the storage battery in the process of equalizing the single batteries in the storage battery pack, the single batteries stop being equalized, and step 1 is re-executed, when the n−1 single batteries are completely equalized, step 4 is entered.

The specific implementation steps of step 1 to step 3 in the present embodiment are basically the same as those of Embodiment 1, and will not be described repeatedly herein.

In step 4, the storage battery pack is charged, and step 2 is re-executed after charging is completed.

In some embodiments of the disclosure, charging is divided into two situations according to the SOC of the storage battery.

In the first situation, when battery equalization is ended, the SOC of the storage battery meets that 80%<SOC<90%, the storage battery may continue to be secondarily equalized. Before equalization, the entire storage battery pack is charged, the photovoltaic controller controls the switches K1 and Qn to be turned on while other switches are in a turn-off state, such that the entire storage battery pack is connected to the DC-DC, and the entire storage battery pack is charged by utilizing the photovoltaic cells. In a case that charging is performed until the SOC of the storage battery reaches 90%, charging is stopped, and step 2 is re-executed.

In the second situation, when battery equalization is ended, the SOC of the storage battery meets that 90%<SOC<100%, the storage battery may continue to be secondarily equalized Before equalization, the entire storage battery pack is charged in the same charging manner as the manner in the first situation, but the charging ending conditions are different. In a case that charging is performed until the maximum voltage of the single battery reaches a rated voltage, charging is stopped, and step 2 is re-executed

In addition, when the load is connected to the DC-DC in the charging process, charging is stopped, and step 1 is re-executed.

### Embodiment 3

The present embodiment relates to a device for equalizing storage battery for a photovoltaic energy storage system. As shown in FIG. 5. the device mainly includes:

a state detection component, configured to judge whether the photovoltaic energy storage system is in an energy storage state, and notify, in a case that, an equalization control component;

the equalization control component, configured to judge whether a storage battery pack needs to be equalized, equalize, in a case that, various single batteries in the storage battery pack, and notify, after equalization is completed, a charging control component; and

the charging control component, configured to charge the entire storage battery pack.

Herein, the device for equalizing storage battery of the present embodiment may be applied to a photovoltaic controller in the photovoltaic energy storage system.

Herein, the state detection component may determine, according to the power generation amount of at least one photovoltaic cell, the SOC of a storage battery and the connection condition of at least one load, a current working state of the photovoltaic energy storage system from the following working states:

the energy storage state, referring to that there is no load connected to a DC-DC of the photovoltaic energy storage system, the at least one photovoltaic cell is in a power generation state and the power generation amount meets the charge requirements of the storage battery, and the at least one photovoltaic cell charges the storage battery through the DC-DC;

a photovoltaic power supply state, referring to that the at least one load is connected to the DC-DC, the at least one photovoltaic cell is in a power generation state and the power generation amount can meet the power supply requirements of the at least one load, and the photovoltaic cell directly supplies power to the load through the DC-DC; and

a storage battery power supply state, referring to that the at least one load is connected to the DC-DC, the at least one photovoltaic cell cannot generate power or is in a power generation state but the power generation amount cannot meet the power supply requirements of the at least one load, and the storage battery pack supplies power to the at least one load through the DC-DC.

Herein, the equalization control component may judge whether a storage battery pack needs to be equalized in the following manner:

in a case that the SOC of the storage battery pack reaches a predetermined threshold and the voltage of a single battery in the storage battery pack meets a predetermined equalization condition, determining that the storage battery needs to be equalized, and in a case that the SOC of the storage battery pack does not reach a predetermined threshold and/or the voltage of a single battery in the storage battery pack does not meet a predetermined equalization condition, determining that the storage battery pack does not need to be equalized.

Herein, the situation that the voltage of a single battery in the storage battery pack meets a predetermined equalization condition refers to that the difference between a maximum voltage of the single battery in the storage battery pack and a average voltage of the storage battery pack is greater than 5% of the average voltage of the storage battery pack; or, the difference between a maximum voltage and a minimum voltage of the single battery in the storage battery pack is greater than 10% of the average voltage of the storage battery pack; and the average voltage of the storage battery pack is an average voltage value of all single batteries in the storage battery pack.

Herein, the equalization control component may equalize the storage battery pack in the following manners:

sorting all single batteries in the storage battery pack according to a voltage level of the single batteries; and

sequentially charging and equalizing the single batteries except for the single battery having the highest voltage in the storage battery pack in an ascending order of the voltage value,

wherein in a case that each single battery is charged and equalized, only the single battery is connected to the DC-DC, the other single batteries are disconnected from the DC-DC, in a case that the absolute value of the difference between the voltage of the single battery and the maximum voltage of the single batteries is less than 2% of the maximum voltage of the single batteries, the single battery stops being charged and equalized, and a subsequent single battery continues to be charged and equalized, and in a case that all the single batteries except for the single battery having the largest voltage in the storage battery pack have been completely charged and equalized, equalization for the storage battery pack is completed.

In at least one alternative embodiment, the charging control component is also configured to secondarily equalize, after continuing to charge the storage battery pack, the storage battery pack in the following manners:

in a case that continuing to charge the storage battery pack, when the SOC of the storage battery pack is greater than 80% and less than 90%, charging the entire storage battery pack, and in a case that the SOC of the storage battery pack reaches 90%, stopping charging, and notifying the equalization control component to secondarily equalize the storage battery pack; and when the SOC of the storage battery pack is greater than 90% and less than 100%, charging the entire storage battery pack, and in a case that the maximum voltage of a single battery in the storage battery pack reaches a rated voltage, stopping charging, and notifying the equalization control component to secondarily equalize the storage battery pack.

In at least one alternative embodiment, the state detection component is also configured to notify, in a case that it is detected that at least one load is connected to the DC-DC of the photovoltaic energy storage system, the equalization control component and the charging control component, and in a case that the equalization control component and the charging control component receive a load connection notification of the state detection component, stop equalizing or charging the storage battery pack.

### Embodiment 4

The present embodiment relates to a photovoltaic energy storage system. As shown in FIG. 1 and FIG. 5, the photovoltaic energy storage system of the present embodiment includes a photovoltaic cell, a photovoltaic controller, a DC-DC, and a storage battery pack, wherein the photovoltaic controller in the present embodiment includes the device for equalizing storage battery in Embodiment 3.

Obviously, the above embodiments are merely examples for clearly illustrating and not limiting the implementation manners. For those of ordinary skill in the art, other variations or changes may be made on the basis of the above description. There is no need and no exhaustion for all implementation manners here. However, obvious variations or changes derived therefrom are still within the protection scope of the disclosure.

What is claimed is:

1. A method for equalizing storage battery for a photovoltaic energy storage system, comprising:
step 1. judging whether a photovoltaic energy storage system is in an energy storage state, in a case that the photovoltaic energy storage system is in the energy storage state, entering step 2, and in a case that the photovoltaic energy storage system is not in the energy storage state, continuing to execute step 1;
step 2, judging whether a storage battery pack needs to be equalized, in a case that the storage battery pack needs to be equalized, entering step 3, and in a case that the storage battery pack need not to be equalized, returning to step 1; and
step 3, equalizing the storage battery pack, and continuing to charge the storage battery pack after equalization is completed.

2. The method as claimed in claim 1, wherein a working state of the photovoltaic energy storage system is determined according to a power generation amount of at least one photovoltaic cell, a State of Charge (SOC) of a storage battery, and a connection condition of at least one load;
the energy storage state refers to that there is no loads connected to a Direct Current-Direct Current converter (DC-DC) of the photovoltaic energy storage system, the at least one photovoltaic cell is in a power generation state and the power generation amount meets the charge requirements of the storage battery, and the at least one photovoltaic cell charges the storage battery through the DC-DC;
a photovoltaic power supply state refers to that the at least one load is connected to the DC-DC, the at least one photovoltaic cell is in a power generation state and the power generation amount can meet the power supply requirements of the at least one load, and the photovoltaic cell directly supplies power to the load through the DC-DC; and
a storage battery power supply state refers to that the at least one load is connected to the DC-DC, the at least one photovoltaic cell cannot generate power or is in a power generation state but the power generation amount cannot meet the power supply requirements of the at least one load, and the storage battery pack supplies power to the at least one load through the DC-DC.

3. The method as claimed in claim 1, wherein judging whether the storage battery pack needs to be equalized in the following manner:
in a case that a State of Charge (SOC) of the storage battery pack reaches a predetermined threshold and the voltage of a single battery in the storage battery pack meets a predetermined equalization condition, determining that the storage battery needs to be equalized, and in a case that the SOC of the storage battery pack does not reach the predetermined threshold and the voltage of the single battery in the storage battery pack does not meet the predetermined equalization condition, determining that the storage battery pack does not need to be equalized.

4. The method as claimed in claim 3, the predetermined equalization condition met by the voltage of a single battery in the storage battery pack refers to that the difference between a maximum voltage of the single battery in the storage battery pack and an average voltage of the storage battery pack is greater than 5% of the average voltage of the storage battery pack; or, a difference between a maximum voltage and a minimum voltage of the single battery in the storage battery pack is greater than 10% of the average voltage of the storage battery pack,
wherein the average voltage of the storage battery pack is an average voltage value of all single batteries in the storage battery pack.

5. The method as claimed in claim 1, wherein the storage battery pack is equalized in the following manners:
sorting all single batteries in the storage battery pack according to a voltage level of the single batteries; and
sequentially charging and equalizing other single batteries in an ascending order of the voltage value, the other single batteries includes single batteries except for the single battery having the highest voltage in the storage battery pack, wherein in a case that each single battery is charged and equalized, only the single battery is connected to the DC-DC, the other single batteries are disconnected from the DC-DC, in a case that the absolute value of the difference between the voltage of the single battery and the maximum voltage of the single batteries is less than 2% of the maximum voltage of the single batteries, the single battery stops being charged and equalized, and a subsequent single battery continues to be charged and equalized, and in a case that all the other single batteries have been completely charged and equalized, equalization for the storage battery pack is completed.

6. The method as claimed in claim 1, further comprising: secondarily equalizing, after continuing to charge the storage battery pack, the storage battery pack in the following manners:
in a case that continuing to charge the storage battery pack, when a SOC of the storage battery pack is less than 90%, charging the entire storage battery pack, and in a case that the SOC of the storage battery pack reaches 90%, stopping charging, and returning to step 2; and
in a case that continuing to charge the storage battery pack, when the SOC of the storage battery pack is greater than 90%, charging the entire storage battery pack, and in a case that the maximum voltage of a single battery in the storage battery pack reaches a rated voltage, stopping charging, and returning to step 2.

7. The method as claimed in claim 6, further comprising:
directly returning to step 1 when it is detected that at least one load is connected to the DC-DC of the photovoltaic energy storage system during step 2, step 3 and step 4.

8. A device for equalizing storage battery for a photovoltaic energy storage system, the device being applied to a photovoltaic controller of a photovoltaic energy storage system, the device comprising:
a state detection component, configured to judge whether the photovoltaic energy storage system is in an energy storage state, and notify, in a case that the photovoltaic energy storage system is in the energy storage state, an equalization control component;
the equalization control component, configured to judge whether a storage battery pack needs to be equalized, equalize, in a case that the storage battery pack needs to be equalized, various single batteries in the storage battery pack, and notify, after equalization is completed, a charging control component; and
the charging control component, configured to charge the entire storage battery pack.

9. The device as claimed in claim 8, wherein the state detection component determines a working state of the photovoltaic energy storage system according to the power generation amount of at least one photovoltaic cell, a State of Charge (SOC) of a storage battery, and a connection condition of at least one load;
the energy storage state refers to that there is no loads connected to a Direct Current-Direct Current converter (DC-DC) of the photovoltaic energy storage system, the at least one photovoltaic cell is in a power generation state and the power generation amount meets the charge requirements of the storage battery, and the at least one photovoltaic cell charges the storage battery through the DC-DC;
a photovoltaic power supply state refers to that the at least one load is connected to the DC-DC, the at least one photovoltaic cell is in a power generation state and the power generation amount can meet the power supply requirements of the at least one load, and the photovoltaic cell directly supplies power to the load through the DC-DC; and
a storage battery power supply state refers to that the at least one load is connected to the DC-DC, the at least one photovoltaic cell cannot generate power or is in a power generation state but the power generation amount cannot meet the power supply requirements of the at least one load, and the storage battery pack supplies power to the at least one load through the DC-DC.

10. The device as claimed in claim 8, wherein the equalization control component judges whether a storage battery pack needs to be equalized in the following manner:
in a case that the State of Charge (SOC) of the storage battery pack reaches a predetermined threshold and the voltage of a single battery in the storage battery pack meets a predetermined equalization condition, determining that the storage battery needs to be equalized, and in a case that SOC of the storage battery pack does not reach the predetermined threshold and the voltage of a single battery in the storage battery pack does not meet the predetermined equalization condition, determining that the storage battery pack does not need to be equalized,
wherein the situation that the voltage of a single battery in the storage battery pack meets a predetermined equalization condition refers to that the difference between a maximum voltage of the single battery in the storage battery pack and a average voltage of the storage battery pack is greater than 5% of the average voltage of the storage battery pack; or, the difference between a maximum voltage and a minimum voltage of the single battery in the storage battery pack is greater than 10% of the average voltage of the storage battery pack; and the average voltage of the storage battery pack is an average voltage value of all single batteries in the storage battery pack.

11. The device as claimed in claim 8, wherein the equalization control component equalizes the storage battery pack in the following manners:
sorting all single batteries in the storage battery pack according to a voltage level of the single batteries; and
sequentially charging and equalizing other single batteries in an ascending order of the voltage value, the other single batteries includes single batteries except for the single battery having the highest voltage in the storage battery pack,
wherein in a case that each single battery is charged and equalized, only the single battery is connected to the DC-DC, the other single batteries are disconnected from the DC-DC, in a case that the absolute value of the difference between the voltage of the single battery and the maximum voltage of the single batteries is less than 2% of the maximum voltage of the single batteries, the single battery stops is charged and equalized, and a subsequent single battery continues to be charged and equalized, and in a case that all the other single batteries have been completely charged and equalized, equalization for the storage battery pack is completed.

12. The device as claimed in claim 8, wherein the charging control component is further configured to secondarily equalize, after continuing to charge the storage battery pack, the storage battery pack in the following manners:
in a case that continuing to charge the storage battery pack, when a SOC of the storage battery pack is less than 90%, charging the entire storage battery pack, and in a case that the SOC of the storage battery pack reaches 90%, stopping charging, and notifying the equalization control component to secondarily equalize the storage battery pack; and when the SOC of the storage battery pack is greater than 90%, charging the entire storage battery pack, and in a case that the maximum voltage of a single battery in the storage battery pack reaches a rated voltage, stopping charging, and notifying the equalization control component to secondarily equalize the storage battery pack.

13. The device as claimed in claim 12, wherein the state detection component is further configured to notify, in a case that it is detected that at least one load is connected to the DC-DC of the photovoltaic energy storage system, the equalization control component and the charging control component, and when the equalization control component and the charging control component receive a load connection notification of the state detection component, stop equalizing or charging the storage battery pack.

14. A photovoltaic energy storage system, comprising at least one photovoltaic cell, a photovoltaic controller, a Direct Current-Direct Current converter (DC-DC), and a storage battery pack, wherein the photovoltaic controller comprises a device for equalizing storage battery as claimed in claim 8.

15. The method as claimed in claim 2, further comprising: secondarily equalizing, after continuing to charge the storage battery pack, the storage battery pack in the following manners:
in a case that continuing to charge the storage battery pack, when a SOC of the storage battery pack is less than 50%, charging the entire storage battery pack, and in a case that the SOC of the storage battery pack reaches 90%, stopping charging, and returning to step 2; and
in a case that continuing to charge the storage battery pack, when the SOC of the storage battery pack is greater than 90%, charging the entire storage battery pack, and in a case that the maximum voltage of a single battery in the storage battery pack reaches a rated voltage, stopping charging, and returning to step 2.

16. The method as claimed in claim 3, further comprising: secondarily equalizing, after continuing to charge the storage battery pack, the storage battery pack in the following manners:
in a case that continuing to charge the storage battery pack, when a SOC of the storage battery pack is less than 90%, charging the entire storage battery pack, and in a case that the SOC of the storage battery pack reaches 90%, stopping charging, and returning to step 2; and
in a case that continuing to charge the storage battery pack, when the SOC of the storage battery pack is greater than 90%, charging the entire storage battery pack, and in a case that the maximum voltage of a single battery in the storage battery pack reaches a rated voltage, stopping charging, and returning to step 2.

17. The method as claimed in claim 4, further comprising: secondarily equalizing, after continuing to charge the storage battery pack, the storage battery pack in the following manners:
in a case that continuing to charge the storage battery pack, when a SOC of the storage battery pack is less than 90%, charging the entire storage battery pack, and in a case that the SOC of the storage battery pack reaches 90%, stopping charging, and returning to step 2; and
in a case that continuing to charge the storage battery pack, when the SOC of the storage battery pack is greater than 90%, charging the entire storage battery pack, and in a case that the maximum voltage of a single battery in the storage battery pack reaches a rated voltage, stopping charging, and returning to step 2.

18. The device as claimed in claim 9, wherein the charging control component is further configured to secondarily equalize, after continuing to charge the storage battery pack, the storage battery pack in the following manners:
in a case that continuing to charge the storage battery pack, when a SOC of the storage battery pack is less than 90%, charging the entire storage battery pack, and in a case that the SOC of the storage battery pack reaches 90%, stopping charge, and notifying the equalization control component to secondarily equalize the storage battery pack; and when the SOC of the storage battery pack is greater than 90%, charging the entire storage battery pack, and in a case that the maximum voltage of a single battery in the storage battery pack reaches a rated voltage, stopping charging, and notifying the equalization control component to secondarily equalize the storage battery pack.

19. The device as claimed in claim 10. wherein the charging control component is further configured to secondarily equalize, after continuing to charge the storage battery pack, the storage battery pack in the following manners:
in a case that continuing to charge the storage battery pack, when a SOC of the storage battery pack is less than 90%, charging the entire storage battery pack, and in a case that the SOC of the storage battery pack reaches 90%, stopping charging and notifying the equalization control component to secondarily equalize the storage battery pack; and when the SOC of the storage battery pack is greater than 90%, charging the entire storage battery pack, and in a case that the maximum voltage of a storage battery in the storage battery pack reaches a rated voltage, stooping charging, and notifying the equalization control component to secondarily equalize the storage battery pack.

20. A photovoltaic energy storage system, comprising at least one photovoltaic cell, a photovoltaic controller, a Direct Current-Direct Current converter (DC-DC), and a storage battery pack, wherein the photovoltaic controller comprises a device for equalizing storage battery as claimed in claim 9.
